(19) United States
(12) Patent Application Publication
(10) Pub. No.: US 2003/0200852 A1
(43) Pub. Date: Oct. 30, 2003

(54) Miter cut fine adjustment mechanism

(76) Inventor: Ezequiel Romo, Chicago, IL (US)

Correspondence Address: GARDNER CARTON & DOUGLAS LLP, 191 N. WACKER DRIVE, SUITE 3700, CHICAGO, IL, 60606, US

(21) Appl. No.: 10/135,299

(22) Filed: Apr. 30, 2002

(51) Int. Cl. B23D 45/14; B23D 47/02; B27B 5/26

(52) U.S. Cl. 83/473; 83/581; 83/468.3

(57) ABSTRACT

A miter cut fine adjustment mechanism for use with a cutting tool for finely adjusting the angle of cut. The miter cut fine adjustment mechanism has a yoke mounted to a lever, the lever attached to a cutting tool for moving the cutting tool into a different angle of cut. An insert is movably secured between the opposing side walls of the yoke for detachably securing the lever to a worktable and the insert is laterally movable for finely adjusting the angle of cut.

### FIELD OF THE INVENTION

The present invention relates generally to a miter cut fine adjustment mechanism for use with a cutting tool, and more specifically, to a miter cut fine adjustment mechanism for a miter saw that allows for adjustment to a number of predetermined positions as well as fine adjustment near the predetermined positions.

### BACKGROUND OF THE INVENTION

Many conventional table saws provide an arrangement where the miter cut angle may be set at a number of predetermined positions. For example, many conventional miter saws provide a circular track that is stationary and mounted on a worktable that provides a plurality of detents that coact and engage with a lever attached to a housing or platform that carries the miter saw. The platform is rotatably connected to the worktable, such that the miter saw, via the interaction between the lever and the detents on the track, may be set to a number of predetermined miter cut positions. For example, such an arrangement might provide a detent at every 15-degree interval. In addition, some miter saws also provide at least some arrangement for adjusting the miter cut position to a location other than the predetermined detent positions. However, due to the interaction between the lever and the detent, the prior art arrangements do not allow for a fine adjustment that is near one of the predetermined detent positions.

One example of the prior art is disclosed in U.S. Pat. No. 5,337,641 to Duginske which discloses a microadjuster mounted to a flip stop assembly on a T-shaped slot in the track of a miter saw. The microadjuster is adjustably secured to the track, such that the rotation of a bolt moves the flipstop assembly either away from or towards a work piece depending on the rotation of the bolt. The flipstop can then be locked into position on the track. As can be easily seen, the use of a microadjuster mounted on the track of a table saw limits the size of the work piece that can be used. Furthermore, a bulky microadjuster located on top of the track of the table saw makes it difficult to use with smaller table saws or miter saws.

Another example of the prior art is discloses in U.S. Pat. No. 5,215,296 to Adams et al. Adams et al. discloses an apparatus for mechanical positioning, and adjustments thereof, of cutting tools such as saws. The apparatus has a microadjustable carriage for use with a work piece such that the carriage rotates relative to the base and moves objects attached to it. Once the desired adjustment has been made, the carriage is secured to the base of the cutting tool using a clamp. One drawback of this type of prior art is its inability for use with table saws that have other than rectangular table tops. It would be impossible to use this apparatus on cutting tools having a circular base, such as miter saws.

A further example of the prior art, most notably those used with miter saws which is is disclosed in U.S. Pat. No. 5,4225,294, is a centering device disclosed by U.S. Pat. No. 5,425,294 to Ushiwata et al. In a desk-top miter saw having a bevel function, a centering system can be used for a zero-tilt angle of the position of cut or for the oft used 45 degree angle of cut. The centering system has a detent lever engaging the worktable at pre-selected positions for changing the angle of cut. They do not, however, provide a mechanism for finely adjusting the angle of cut, such that the angle can be adjusted plus or minus a few degrees of the selected position.

As the prior art examples show, a number of disadvantages remain. First, no prior art provides a fine adjustment mechanism for use with a cutting tool having a circular base, such as a miter saw. Those that disclose the use of a lever to position a cut, fail to provide a mechanism for micro adjustments. Furthermore, it is difficult to finely adjust the lever as the lever normally engages a recessed area in a worktable. As the lever moves within a few degrees of the recessed area in the worktable, the lever naturally propagates into the recessed area making it very difficult for micro adjustments. Second, the prior art does not provide for an easy method of making a fine adjustment as most fine adjustment mechanisms are bulky or must be clamped into position. Finally, the prior art micro adjustment mechanisms, because of the number of parts needed to create the device, are not economically viable.

Therefore, what is needed is a fine adjustment mechanism whereby the user can quickly and easily make slight adjustments to the angle of cut. What is further needed is a fine adjustment mechanism that is smaller, more efficient and more economical. What is further needed is a fine adjustment mechanism for use with a variety of saws, such as miter saws and table saws, such that the cutting tool can be quickly adjusted for a specific angle of cut.

### SUMMARY OF THE INVENTION

The present invention satisfies the need for an economical and efficient fine adjustment system for use with a variety of saws, including a miter saw. The present invention provides a fine adjustment mechanism that is attached to a lever such that the lever and the cutting tool can finely adjust the angle of cut.

The present invention provides a lever having an insert for making fine adjustments of an angle of cut. The insert is attached to the lever via a yoke. The yoke is mounted to the lever and has two opposing side walls. The insert is movable along a rod between the two opposing side walls, the rod having a knob on one end for finely adjusting the insert. As the knob is rotated, the insert moves laterally along the rod, thus rotating the cutting tool into a slightly different position of cut. The fine adjustment mechanism adjusts the angle of the cut a few degrees in either direction and is limited only by the distance between the two opposing side walls of the yoke as will be appreciated by one ordinarily skilled in the art.

The above advantages, features and aspects of the present invention are readily apparent from the following detailed description, appended claims and accompanying drawings.

### BRIEF DESCRIPTION OF THE DRAWINGS

FIG. 1 is a perspective exploded view of a miter cut fine adjustment mechanism for use with a cutting tool according to the present invention;

FIG. 2 is a perspective view of the miter cut fine adjustment mechanism of FIG. 1;

FIG. 3 is a side view of the miter cut fine adjustment mechanism of FIG. 2;

FIG. 4 is a top view of a miter cut fine adjustment mechanism of FIG. 3;

FIG. 5 is a bottom view of a miter cut fine adjustment mechanism of FIG. 4;

FIG. 6 is a perspective view of a miter cut fine adjustment mechanism for use with a cutting tool illustrating the rotational direction of the handle according to the present invention;

FIG. 7 is a partial perspective view of a miter cut fine adjustment mechanism for use with a cutting tool illustrating the rotational direction of the fine adjustment knob according to the present invention; and

FIG. 8 is a partial top view of a miter cut fine adjustment mechanism for use with a cutting tool illustrating the lateral movement of the insert according to the present invention.

### DETAILED DESCRIPTION OF THE INVENTION

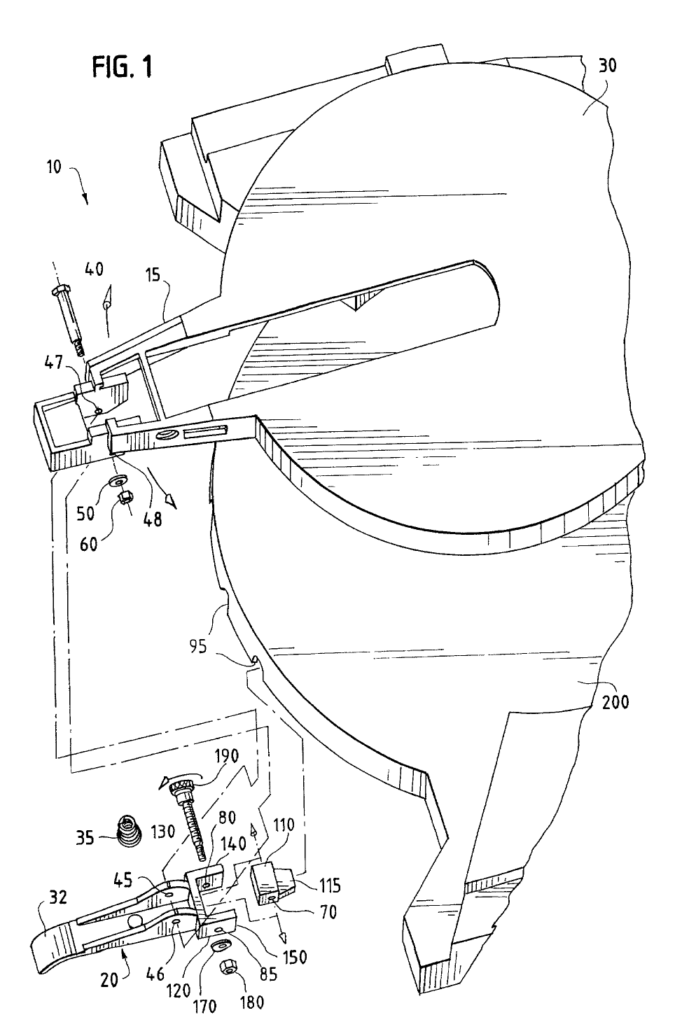

Turning first to FIG. 1, there is illustrated, in accordance with a first embodiment of the present invention, a fine adjustment mechanism 10 for use with a cutting tool (not shown) secured to a base 200. The turntable 30 is rotatably supported by the base 200, such that the cutting tool can be rotated to a selected angle of cut without moving the base 200. The rotatable turntable 30 has an outwardly extending arm 15 for securing a lever 20, the lever 20 being able to rotate the turntable 30 and the cutting tool for a selected angle of cut. The outwardly extending arm 15 is mounted to the turntable 30, or alternatively, may be an extension of the original molded base as may be appreciated by one skilled in the art.

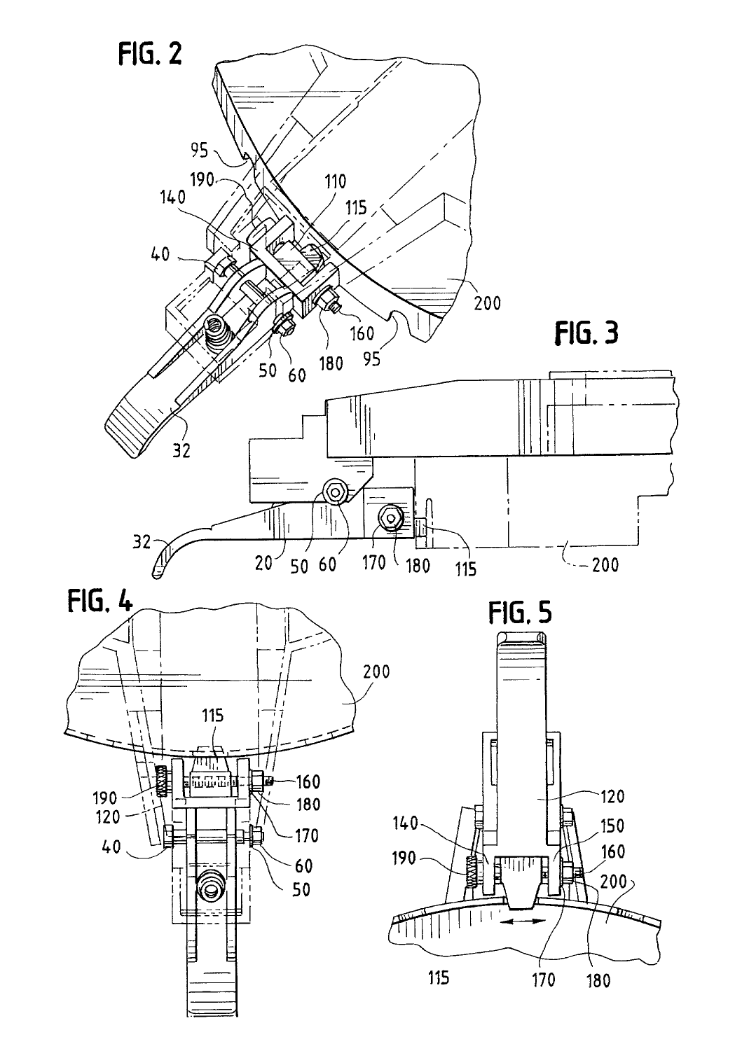

As is illustrated in FIGS. 1-2, there is provided a bolt 40 for securing the lever 20 to the extending arm 15 of the turntable 30. The lever 20 has a pair of openings 45, 46 that are aligned with a pair of openings 47, 48 on the outwardly extending arm 15. The lever 20 is secured to the outwardly extending arm 15 of the turntable 30 with the bolt 40, a washer 50 and a nut 60. The bolt 40 has a threaded end and extends through the pair of openings 47, 48 of the outwardly extending arm 15 of the turntable 30 and through the pair of openings 45, 46 of the lever 20. The washer 50 and nut 60 threadably receive the bolt 40, thereby securing the lever 20 to the turntable 30, such that the turntable 30, and consequently, the cutting tool, are movable in multiple directions for selecting the angle of cut.

FIGS. 1-5 illustrate a yoke 120 securely mounted to the end of the lever 20, adjacent to the pair of openings 45, 46 along the upper edge 130 of the yoke 120. The yoke 120 has two opposing side walls 140, 150, each opposing side wall 140, 150 substantially perpendicular to the upper edge 130. An insert 110 is positioned between the opposing side walls 140, 150 for finely adjusting the position of the lever 20. The insert 110 has a threaded cavity 70 and each opposing side wall 140, 150 has an aperture therethrough for receiving a threaded rod 160. The threaded rod extends through the first aperture 80, passes through the threaded cavity 70 of the insert 110 and continues through the second aperture 85.

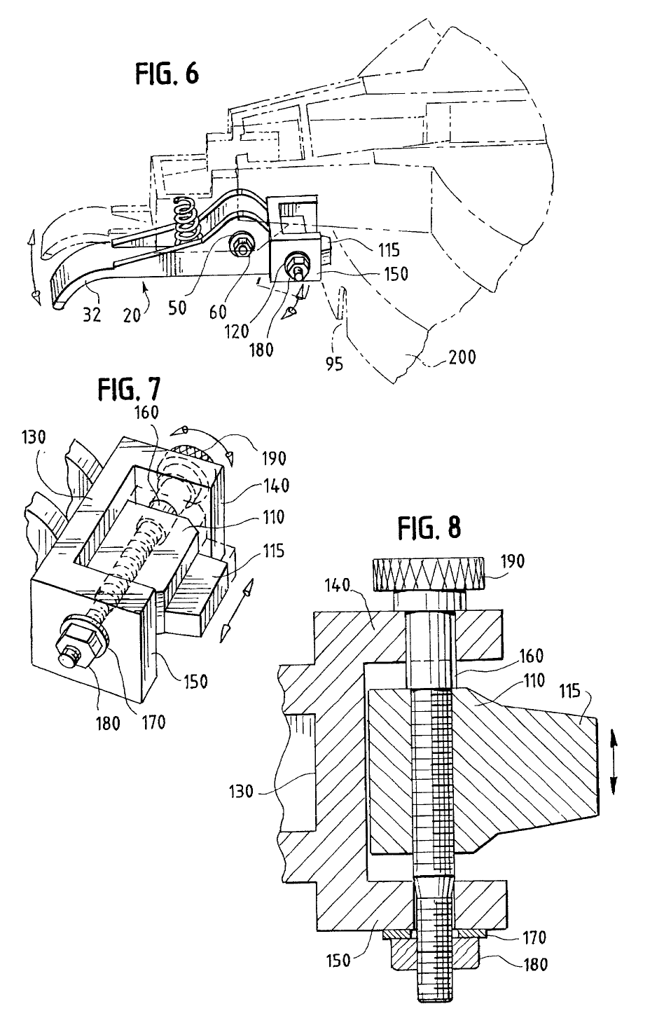

As can be seen in FIGS. 6-8, the insert 110 is laterally moveable along the threaded rod 160 between the opposing side walls 140, 150. A washer 170 and a nut 180 secure one end of the rod 160 to the outer area of one of the opposing side walls 140. A knob 190 is attached to the other end of the rod 160 on the outer area of the other opposing side wall 150 such that the knob 190, when rotated about the axis of the rod 160, can move the insert 110 laterally along the rod 160. The insert 110 moves in a direction towards either opposing wall 140, 150 as determined by the rotational movement of the knob 190 with respect to the rod 160 as shown in FIG. 7.

The insert 110 has a protuberance 115 mounted to the insert or alternatively, is a molded portion thereof as will be appreciated by one skilled in the art, extending in a direction distal the upper edge 130 of the yoke 120, permitting the lever 20 to be detachably secured to a recessed area or slot 95 in the base 200 about which the rotational turntable 30 is secured. The lever 20 is secured to the rotatable turntable 30 such that the lever 20 can rotate the cutting tool to other recessed areas or slots 95 in the base 200 for selecting a different angle of cut. The lever 20 has a handle 32 such that the user can move the lever 20, as shown in FIG. 6, out of the recessed area 95 and rotate or slide the lever 20 into a new position by releasing the lever 20 into an alternative recessed area 95 such that the lever 20 re-engages the base 200. Upon selecting a new angle of cut, the knob 190 can then be rotated in either direction for finely adjusting the selected angle of the lever 20 and, as a result, of the cut along the plane of the base 200. The degree of fine adjustment of the lever 20 is limited only by the length between the two opposing side walls 140, 150 of the yoke 120. As will be appreciated by one of ordinary skill in the art, the greater the distance between the opposing side walls 140, 150, the greater the degree of fine adjustment of the lever 20 and subsequently the cutting tool.

The lever may further have a spring 35 attached to the lever 20 for biasing the lever 20 and the extending arm 15 of the turntable 30.

While only a few embodiments of the miter cut fine adjustment mechanism for use with a cutting tool of the present invention have been described and illustrated in detail herein, it will be evident to one of ordinary skill in the art that other embodiments may be possible without departing from the scope of the following claims.

What is claimed is:

1. A fine adjustment mechanism for use with a cutting tool attached to a base, the base rotatably attached to a worktable, the fine adjustment mechanism comprising:
a yoke having two opposing sidewalls, the side-walls attached to the base;
a lever attached to yoke, the lever for rotating the base to a first cutting position;
an insert rotatably attached to the yoke between the opposing sidewalls;
a protuberance attached to the insert, the protuberance positioned to contact to worktable;
wherein rotation of the insert moves the protuberance against the worktable such that the base rotates to a second cutting position.

2. The fine adjustment mechanism of claim 1 wherein the insert has a threaded cavity and the opposing sidewalls each has an aperture therethrough.

3. The fine adjustment mechanism of claim 2 further comprising a threaded rod threaded through the threaded cavity.

4. The fine adjustment mechanism of claim 3 further comprising a fine adjustment knob, the fine adjustment knob attached to one end of the threaded rod such that when the knob is rotated the insert moves laterally along the threaded rod.

5. A cutting tool assembly comprising:
a worktable;
a base rotatably attached to the worktable;
a cutting tool attached to the base;
a yoke having two opposing sidewalls, the sidewalls attached to the base;
a lever attached to the yoke, the lever for rotating the base to a first cutting position;
an insert laterally slidably attached to the yoke between the opposing sidewalls; and
a protuberance attached to the insert, the protuberance positioned to contact the worktable;
wherein the lateral slide of the insert moves the protuberance against the worktable such that the base rotates to a second cutting position.

6. The cutting tool assembly of claim 5 wherein the insert has a threaded cavity and the opposing sidewalls each has an aperture therethrough.

7. The cutting tool assembly of claim 6 further comprising a threaded rod threaded through the threaded cavity.

8. The cutting tool assembly of claim 7 further comprising a fine adjustment knob, the fine adjustment knob attached to one end of the threaded rod such that when the knob is rotated the insert moves laterally along the threaded rod.

9. A cutting tool assembly comprising:
a worktable;
a base rotatably attached to the worktable;
a cutting tool attached to the base;
a first means for rotating the base to a first cutting position; and
a second means for rotating the base rotates to a second cutting position.

10. The cutting tool assembly of claim 9 wherein the first rotating means comprises a yoke having two opposing sidewalls, the sidewalls attached to the base.

11. The cutting tool assembly of claim 10 wherein the first rotating means further comprises a lever attached to the yoke.

12. The cutting tool assembly of claim 11 wherein the second rotating means comprises an insert rotatably attached to the yoke between the opposing sidewalls.

13. The cutting tool assembly of claim 12 wherein the second rotating means further comprises a protuberance attached to the insert, the protuberance positioned to contact the worktable.

14. The cutting tool assembly of claim 14 wherein the insert has a threaded cavity and the opposing sidewalls each has an aperture therethrough.

15. The cutting tool assembly of claim 14 further comprising a threaded rod threaded through the threaded cavity.

16. The cutting tool assembly of claim 15 further comprising a fine adjustment knob, the fine adjustment knob attached to one end of the threaded rod such that when the knob is rotated the insert moves laterally along the threaded rod.
